(19) United States
(12) Patent Application Publication
(10) Pub. No.: US 2005/0194495 A1
(43) Pub. Date: Sep. 8, 2005

(54) Aircraft landing gear

(76) Inventor: Taehun Seung, Scheidegg (DE)

Correspondence Address: DILWORTH & BARRESE, LLP, 333 EARLE OVINGTON BLVD., UNIONDALE, NY, 11553, US

(21) Appl. No.: 10/933,715

(22) Filed: Sep. 3, 2004

(30) Foreign Application Priority Data
Sep. 3, 2003 (DE) 10340650.6

(51) Int. Cl. B64C 25/42

(52) U.S. Cl. 244/111

(57) ABSTRACT

The present invention relates to aircraft landing gear having a landing gear brake to brake at least one landing gear wheel and a hydraulic supply for the actuation of the landing gear brake. The landing gear is characterized in accordance with the invention in that the hydraulic supply has a hydraulic pump drivable by a landing gear wheel.

The present invention relates to aircraft landing gear having a landing gear brake to brake at least one landing gear wheel and a hydraulic supply for the actuation of the landing gear brake.

Aircraft landing gear is braked hydraulically as a rule, with the hydraulic energy required for the actuation of the brake as a rule being taken from the hydraulic supply supplying the corresponding landing gear. In recent times, considerations have been made to no longer feed the landing gear actuation from the central hydraulic supply of the airplane, but to provide a local hydraulic supply for the landing gear actuation. However, with such local hydraulic supplies, no fail-safe system is easily available by which the redundancy required for safety would be ensured. The availability of the supply of the landing gear brake on a failure of the said local supply must therefore be ensured or generally increased. It would furthermore be desirable to improve the effectiveness of the energy balance and the associated infrastructure. It is a problem with conventional hydraulic supply systems that appropriately dimensioned supply units, including lines, must be made available for redundancy reasons and to cover singular supply peaks which are, however, actually only in operation for minimum time periods.

It is therefore the underlying object of the present invention to provide improved aircraft landing gear which avoids disadvantages of the prior art and further develops said prior art in an advantageous manner. The availability of the brakes should preferably be increased and the effectiveness of the energy balance should be significantly improved.

This object is solved in accordance with the invention by aircraft landing gear in accordance with claim 1. Preferred aspects of the invention form the subject of the dependent claims.

In accordance with the invention, the hydraulic supply for the actuation of the landing gear brake therefore comprises a hydraulic pump which is associated with a landing gear wheel, is passively driven by the said landing gear wheel during ground operation and can in particular form an additional hydraulic supply.

Due to the appropriate drive connection between the hydraulic pump and the wheel of the landing gear, the rotation of the wheel drives the hydraulic pump, whereby the hydraulic supply of the landing gear brake is ensured. Such a hydraulic pump driven by a landing gear wheel for the supply of the brakes of the aircraft has a variety of advantages. On the one hand, the total energy balance of the airplane can be improved. During the landing, the pump converts the kinetic energy of the airplane, which is not wanted at this moment, into the hydraulic energy required for the braking process, and indeed beginning just before the point in time it is actually needed and as long as the airplane is moving. As a rule, airplane pilots or airplane controls namely ensure that the airplane does not touch down on the runway with already braked wheels or that the landing gear brakes can only be actuated with a certain time offset after the actual touchdown in order to ensure that all landing gear wheels are actually on the ground. This time offset, which can be very small and can amount to only a few fractions of a second, is sufficient to start the hydraulic pump driven by the landing gear wheel and to make the braking energy available. The hydraulic energy generated should primarily support the functioning system supply. In the event of a malfunction (failure of the regular energy supply), it can completely take over the hydraulic energy supply required for the brake actuation. It is particularly advantageous with respect to the energy balance that the kinetic energy of the airplane is converted directly into hydraulic energy so that it can be used for the actuation of the hydraulic aircraft brakes without any further conversion.

Furthermore, the hydraulic pump driven by the landing gear wheel is absolutely independent of the other energy sources of the airplane so that the availability of the brakes can be increased. It is a further advantage that the hydraulic pump coupled to the landing gear wheel can be used to brake the corresponding landing gear wheel or landing gear wheels after take-off when the landing gear is to be retracted. In some cases, special landing gear brakes are used for this purpose, for example in the form of brake spring shackles acting on the tires. The unwanted kinetic energy can be eradicated faster via the hydraulic pump driven by the rotation of the wheel. As a consequence, this braking on the retraction of the landing gear after take-off can be simplified.

In a further development of the invention, the hydraulic pump driven by the landing gear wheel sits directly on the landing gear wheel, in particular on the interior of the space encircled by the wheel tire.

A very compact arrangement can be achieved by the arrangement of the hydraulic pump in the rim cavity; moreover it is protected by the rim or the wheel tire surrounding it. The hydraulic pump can preferably sit on the wheel hub.

Landing gear of modem passenger aircraft as a rule includes main landing gear and nose landing gear. With such a design of the landing gear, it would generally be conceivable to arrange the said hydraulic pump at one of the main landing gear arrangements. It is, however, substantially more advantageous, in accordance with a preferred embodiment of the invention, for the hydraulic pump to be arranged at the nose landing gear since there is more room available there to arrange the additional components. Normally, no brakes are provided at the nose landing gear so that there is in particular space in the region of the wheel hub to arrange the hydraulic pump. The coupling of the hydraulic pump to the nose landing gear wheels moreover has the advantage that a certain braking effect also occurs at the nose landing gear by the drive resistance of the pump. This braking action moreover has the additional advantageous effect that the pitch movement of the airplane caused thereby increases the contact pressure at the nose landing gear and that the ground adhesion is hereby improved.

Differently designed hydraulic pumps can generally be used. In a further development of the invention, a hydraulic pump whose delivery volume is adjustable is coupled to the landing gear wheels. It is possible with a hydraulic pump having an adjustment device to adjust the delivery volume to set the delivery amount or the delivery pressure in the desired manner, preferably to keep it as constant as possible. The delivery volume can preferably also be run at zero using the adjustment device so that the hydraulic pump runs on no load. The corresponding landing gear wheel can completely free-wheel in this position. This is in particular advantageous with the said arrangement of the hydraulic pump at the nose landing gear, since the pump can be kept in the non-load position during the start and during taxiing operation, whereby neither the acceleration procedure nor the maneuverability of the nose wheel steering is influenced. An axial piston pump having an adjustable stroke regulation mechanism can in particular be used as the hydraulic pump.

The adjustment device of the hydraulic pump can advantageously be controlled electrically. The adjustment device is advantageously made such that it automatically reverts to the non-load position on a failure of the electrical actuation apparatus. Such an automatic reverter has the advantage that it is ensured, on a failure of the electrical actuation apparatus, that the nose wheel is resistance-free and is freely rotatable.

Equally, the hydraulic supply into which the hydraulic pump driven by the landing gear wheel feeds is not a hydraulic supply provided exclusively for the actuation of the landing gear brakes. The said hydraulic supply can advantageously also be connected, in addition to the landing gear brake, to further actuators for the actuation of the landing gear, in particular for the opening and closing of a landing gear flap, for the extension and retraction of the landing gear, for the latching of the landing gear and/or for the steering of the landing gear, The hydraulic supply, however, advantageously forms a local hydraulic supply which is provided solely for the landing gear actuation, including the actuation of the landing gear brakes. The hydraulic supply has a main pump drivable by an electrical motor in addition to the hydraulic pump driven by the landing gear wheel. The hydraulic pump driven by the landing gear wheel only forms an additional pump which provides energy for the braking of the landing gear wheels.

In a further development of the invention, the hydraulic pump driven by the landing gear wheel feeds a hydraulic accumulator connectable to the landing gear brake. On the other hand, the said hydraulic pump can be connected at its suction side to a central low-pressure reservoir of the hydraulic supply. The hydraulic accumulator from which the landing gear brake is fed is advantageously likewise connectable to the main pump of the hydraulic supply so that redundancy is achieved.

The said hydraulic supply for the landing gear actuation into which the hydraulic pump arranged at the nose landing gear feeds is the hydraulic supply of the main landing gear in a further development of the invention. The hydraulic pump arranged at the nose landing gear is connected for this purpose to the hydraulic supply of the main landing gear via at least one pressure line. To the extent that the hydraulic supply of the main landing gear has two branches, namely for the left main landing gear and for the right main landing gear, the hydraulic source arranged at the nose landing gear is expediently connected to the right hand strand and to the left hand strand of the main landing gear hydraulic supply via two pressure lines. In addition, the hydraulic pump on the nose landing gear side is connected to the central low-pressure reservoir of the main landing gear supply via a further hydraulic line so that three hydraulic lines are provided in total.

As a rule, the nose landing gear of commercial transport airplanes has more than one landing gear wheel. In this case, two hydraulic pumps are advantageously provided at the nose landing gear, one of which is coupled to a first landing gear wheel and the other of which is coupled to a further landing gear wheel. The pressure outlets of the two hydraulic pumps are advantageously connected to the left-hand strand of the main landing gear hydraulic supply, on the one hand, and to the right-hand strand of the main landing gear hydraulic supply, on the other hand.

In a further development of the invention, the hydraulic lines between the at least one hydraulic pump arranged at the nose landing gear side and the hydraulic supply of the main landing gear are also used to secure against failure or to completely take over the hydraulic supply at the nose landing gear side for the extension and retraction of the nose landing gear, for the actuation of the corresponding nose landing gear flaps and for the control of the nose landing gear. The at least one hydraulic line, which connects the at least one hydraulic pump at the nose landing gear side to the hydraulic supply of the main landing gear, can preferably be switched for this purpose via at least one electromagnetic switching valve into a connection of the hydraulic supply of the main landing gear to the hydraulic supply of the nose landing gear.

The invention will be explained in more detail in the following with reference to preferred embodiments and to associated drawings. There are shown in the drawings:

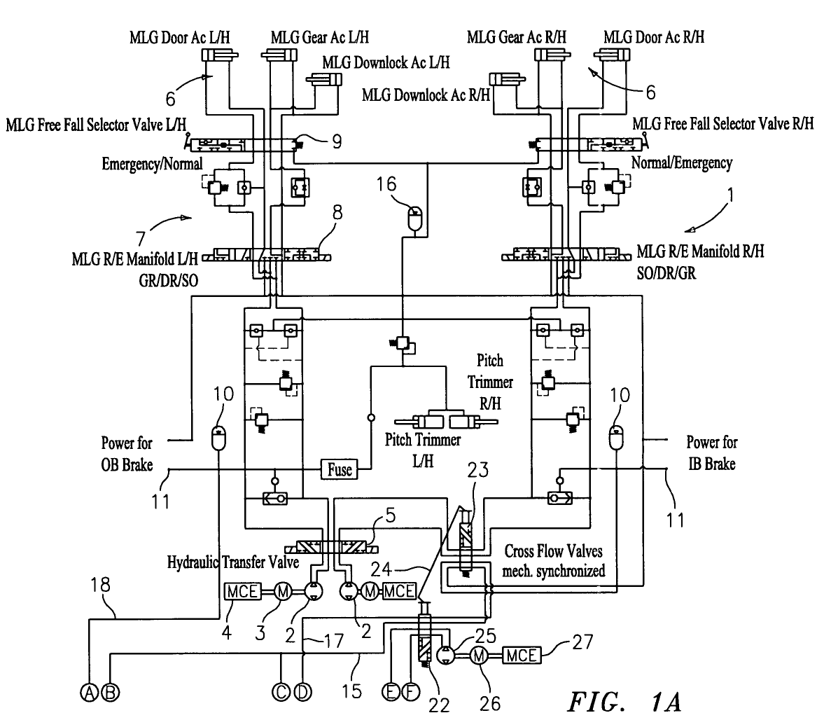

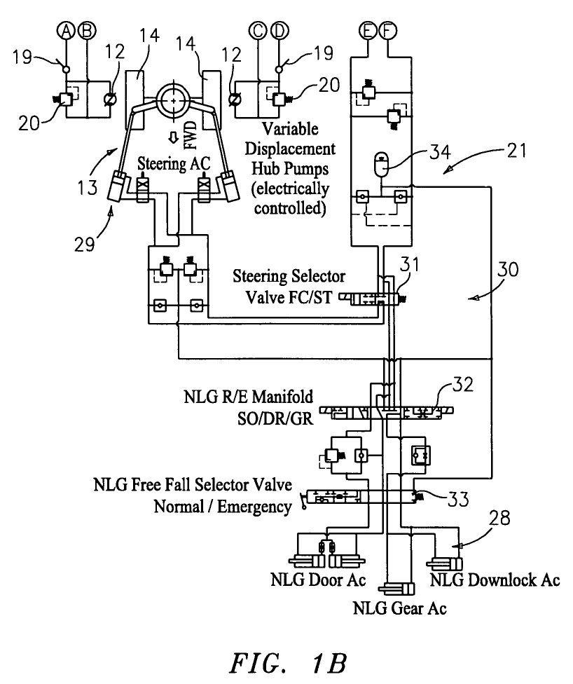

FIG. 1: a schematic representation of the hydraulic supplies of a main landing gear assembly and of a nose landing gear assembly of an aircraft in a circuit diagram, with the nose landing gear and hydraulic supply points associated with it as well as their connection to the hydraulic supply of the main landing gear for the provision of hydraulic braking energy likewise being shown schematically.

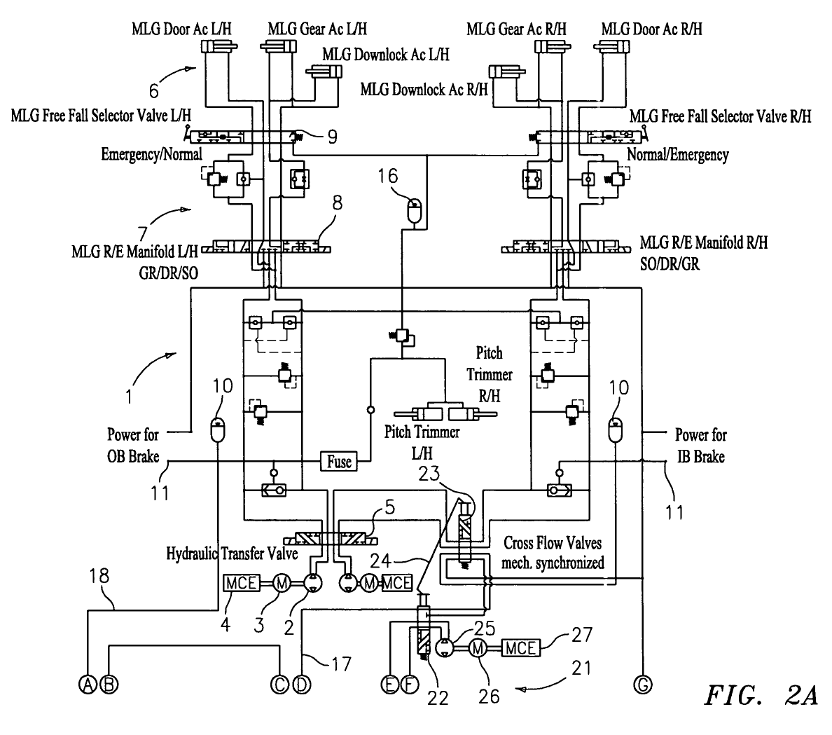

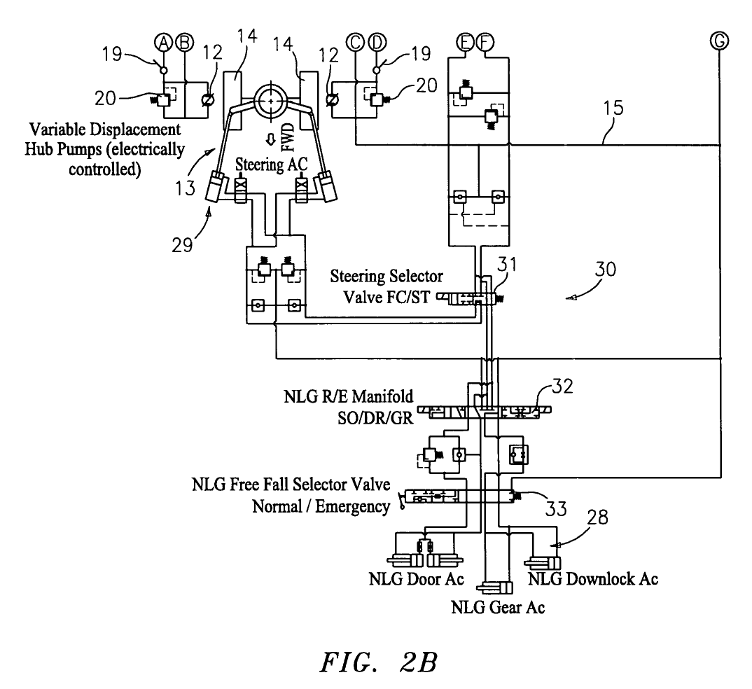

FIG. 2: a schematic representation of a main landing gear assembly and of a nose landing gear assembly of an airplane in accordance with a further preferred embodiment of the invention, with the nose landing gear and hydraulic pumps connected thereto for the generation of hydraulic braking energy as well as their connection to the hydraulic supply of the main landing gear likewise being shown.

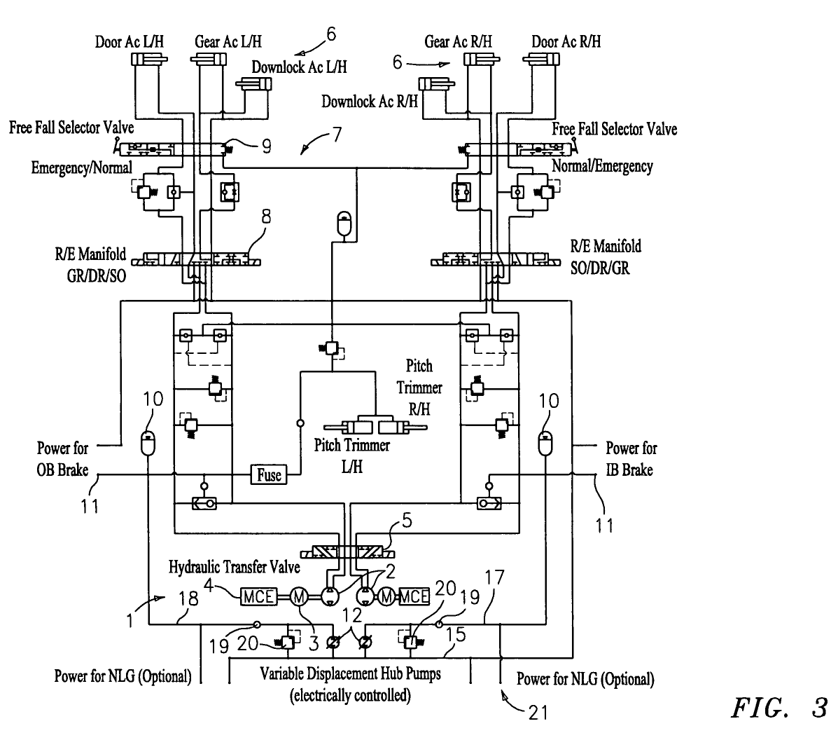

FIG. 3: a schematic representation of a joint hydraulic supply for the main landing gear and for the nose landing gear in a circuit diagram, with hydraulic pumps provided at the nose landing gear for the generation of braking energy likewise being connected to the hydraulic supply.

As FIG. 1 shows, the hydraulic supply 1 of the main landing gear comprises two hydraulic pumps 2, which are driven via electrical motors 3 controlled by control units 4. The two hydraulic pumps 2 actually feed the right hand main landing gear and the left hand main landing gear separately, but can each be switched to the other main landing gear via the switching valve 5 on the failure of the respective other pump. Actuators 6 can be acted on by the hydraulic fluid provided by the hydraulic pumps 2 and are provided for the actuation of a landing gear flap, for the retraction and extension of the landing gear and for the unlatching of the landing gear. The actuators 6 can be connected to the respective hydraulic pump 2 via a valve arrangement 7, with the valve arrangement 7 being made such that always only a maximum of one actuator can be connected to the hydraulic pump 2. As FIG. 1 shows, the valve arrangement 7 consists of switching valves 8 and 9 which are connected in series and which, at the output side, always only open one output passage or one output passage pair consisting of a supply and return line.

The hydraulic pumps 2 of the hydraulic supply 1 of the main landing gear furthermore each feed a hydraulic accumulator 10 or a pressure connection 11 which is connected thereto and which makes available the hydraulic pressure required for the hydraulic brakes (now drawn separately) of the main landing gear for the actuation of the brakes. Hydraulic landing gear brakes and the corresponding actuators for their actuation are known per se so that they do not have to be explained separately.

As FIG. 2 shows, the hydraulic accumulator 10 and the pressure connection 11 for the hydraulic brakes of the main landing gear are fed by two additional hydraulic pumps 12 which are arranged at the nose landing gear 13 and are coupled to the wheels 14 of the nose landing gear 13 such that they are driven by the rotation of the nose landing gear wheels 14.

The hydraulic pumps 12 are in particular installed in the same cavity of the respective nose landing gear wheel 14. The hydraulic pumps 12 are here made as axial piston pumps which have an adjustable stroke regulation mechanism and thus a settable delivery volume. An adjustment device is associated with the swash plate and an electrical actuation device is in turn associated with the former so that the delivery volume of the hydraulic pumps 12 is electronically controllable.

As FIG. 2 shows, the suction sides of the hydraulic pump 12 are connected to the joint low-pressure reservoir 16 of the hydraulic supply 1 of the main landing gear via a hydraulic line 15. The high pressure sides of the hydraulic pumps 12 are connected to the hydraulic accumulators 10 or to the pressure connections 11 fed by them for the hydraulic brakes of the main landing gear via hydraulic lines 17 and 18. Check valves 19 are connected in each of the hydraulic lines 17 and 18 and prevent a return flow of the hydraulic fluid from the hydraulic accumulator 10. Furthermore, the high pressure sides of the hydraulic pumps 12 are connected to the low pressure sides via a circuit, with this connection being blocked by pressure-controlled valves 20 as long as the pressure at the high pressure side does not exceed a pre-determined value. The circuit is only opened when the pressure at the high pressure side becomes too high.

As FIG. 2 shows, the high pressure hydraulic line 17 between the hydraulic pump 12 and the hydraulic accumulator 10 for the supply of the brakes is also used for an emergency switching. For the event that the hydraulic supply 21 of the nose landing gear fails, the hydraulic source of the hydraulic supply 1 of the main landing gear can be switched to the hydraulic supply 21 of the nose landing gear by actuation of the two switching valves 22 and 23. For this purpose, the hydraulic line 17 is cut off from the hydraulic pump 12 which can in turn be connected to the pressure line of the hydraulic pump 2 of the hydraulic supply 1 of the main landing gear via the valve 23. An additional return line is likewise connected. The two switching valves 22 and 23 are advantageously synchronized, preferably via a mechanical coupling 24. The mechanical coupling 24 can, for example, consist of a pulley mechanism to which both valves 22 and 23 are connected and which synchronously actuates the valves. Alternatively, an electromagnetic valve can also be provided which is connected via a cable or via a rod to the second valve which can be of a mechanical design. An electrical coupling can also be provided instead of a mechanical coupling. The two valves can here each have one solenoid which can be synchronized with one another via software.

The hydraulic lines 17, 18 to be laid between the hydraulic pumps 12 at the nose landing gear 13 and the brakes at the main landing gear can accordingly therefore be used for a dual function. They not only serve the supply of the brakes of the pumps on the nose landing gear side, but also the supply of the nose landing gear when its hydraulic pressure source 25 fails. As FIG. 2 shows, the hydraulic supply 21 of the nose landing gear has its own hydraulic pump 25 which can be driven by a motor 26 which can be controlled by a control 27. In a similar manner to the hydraulic supply 1 of the main landing gear, actuators 28 can be acted on by the hydraulic pressure generated by the pump 25 which serve the actuation of the nose landing gear 13, in particular for the actuation of the nose landing gear flaps, for the retraction and extension of the nose landing gear and for the unlatching of the nose landing gear. Furthermore, actuators 29 for the control of the nose landing gear can be acted on thereby. In a similar manner to the main landing gear hydraulic supply, the actuators 28 and 29 can also be connected to the same hydraulic supply source, namely to the pump 25, via a valve arrangement 30 with the hydraulic supply 21 of the nose landing near, with the valve arrangement 30 being made such that always only a maximum of one actuator can be connected to the hydraulic supply source. The valve arrangement 30, as FIG. 1 shows, in particular consists of switching valves 31, 32 and 33 which are connected in series and which, at the output side, always only open one output passage or one output passage consisting of a supply and a return line.

The apparatus shown in FIG. 2 largely corresponds to that just described in accordance with FIG. 1. In contrast to the arrangement in accordance with FIG. 1, the hydraulic supply 21 of the nose landing gear does not here have its own low pressure reservoir, which is designated by the reference numeral 34 in FIG. 1, but is connected to the suction line 15 of the hydraulic pumps 12 which in turn communicates with the low pressure reservoir 16 of the hydraulic supply 1 of the main landing gear.

Finally, FIG. 3 shows an arrangement which likewise largely corresponds to the arrangement described in connection with FIG. 1, but differs from this in that the hydraulic supply 21 of the nose landing gear does not have its own hydraulic pressure shaft, but is supplied by the hydraulic pressure shaft of the hydraulic supply 1 of the main landing gear, i.e. its hydraulic pumps 2.

However, the hydraulic pumps 12 connected to the nose landing gear wheels are also provided here which feed the pressure reservoir 10 and the pressure connection 11 for the main landing gear brakes connected to it.

1. Aircraft landing gear having a landing gear brake to brake at least one landing gear wheel and a hydraulic supply (1) for the actuation of the landing gear brake, characterized in that
the hydraulic supply (1) has a hydraulic pump (12) drivable by a landing gear wheel.

2. Aircraft landing gear in accordance with claim 1, wherein the hydraulic pump (12) sits directly on the landing gear wheel (14), in particular on the wheel hub in the rim cavity of the landing gear wheel (14).

3. Aircraft landing gear in accordance with claim 1, wherein it comprises a nose landing gear (13) and two main landing gears and the hydraulic pump (12) is arranged on the nose landing gear (13) and can be connected to the hydraulic supply (1) of the landing gear brakes of the main landing gear via hydraulic lines (15, 17, 18).

4. Aircraft landing gear in accordance with claim 1, wherein a fuselage landing gear assembly and two main landing gears are provided and the hydraulic pump (12) is arranged at the fuselage landing gear and can be connected to the hydraulic supply of the landing gear brakes of the main landing gears via hydraulic lines.

5. Aircraft landing gear in accordance with claim 1, wherein the hydraulic pump (12) is provided with an adjustment device for the adjustment of the delivery volume, is in particular made as an axial piston pump with an adjustable stroke regulation mechanism.

6. Aircraft landing gear in accordance with claim 5, wherein the adjustment device has an electrical actuation apparatus and runs on its own without an electrical actuation in a non-load position in which the delivery volume of the pump is substantially zero.

7. Aircraft landing gear in accordance with claim 1, wherein the hydraulic supply (1) forms a local hydraulic supply which is provided solely for the landing gear actuation and/or can also be connected, in addition to the landing gear brake, to actuators (6) for the opening and closing of a landing gear flap, for the retraction and extension of the landing gear and/or for the latching of the landing gear.

8. Aircraft landing gear in accordance with claim 1, wherein the hydraulic supply (1) has a main pump (2) which can be driven by an electric motor (3) and the hydraulic pump (12) coupled to the landing gear wheel (14) forms an additional pump.

9. Aircraft landing gear in accordance with claim 1, wherein the hydraulic pump (12) feeds a hydraulic accumulator (10) which can be connected to the landing gear brake.

10. Aircraft landing gear in accordance with claim 1, wherein the hydraulic pump (12) coupled to the landing gear wheel (14) is connected to a central low pressure reservoir (16) of the hydraulic supply (1).

11. Aircraft landing gear in accordance with claim 1, wherein two hydraulic pumps are provided each coupled to one nose landing gear wheel (14), one of the two hydraulic pumps (12) is connected to the hydraulic supply (1) of a right hand main landing gear assembly and the other of the two hydraulic pumps (12) is connected to the hydraulic supply (1) of a left hand main landing gear assembly.

12. Aircraft landing gear in accordance with claim 1, wherein at least one hydraulic line (17), which connects the at least one hydraulic pump (12) at the nose landing gear side and the hydraulic supply (1) of the main landing gear, can preferably be switched via at least one electromagnetic switching valve (22, 23) into a connection of the hydraulic supply (1) of the main landing gear to the hydraulic supply (21) of the nose landing gear.

13. Aircraft landing gear in accordance with claim 2 wherein it comprises a nose landing gear (13) and two main landing gears and the hydraulic pump (12) is arranged on the nose landing gear (13) and can be connected to the hydraulic supply (1) of the landing gear brakes of the main landing gear via hydraulic lines (15, 17, 18).

14. Aircraft landing gear in accordance with claim 2, wherein a fuselage landing gear assembly and two main landing gears are provided and the hydraulic pump (12) is arranged at the fuselage landing gear and can be connected to the hydraulic supply of the landing gear brakes of the main landing gears via hydraulic lines.

15. Aircraft landing gear in accordance with claim 3, wherein a fuselage landing gear assembly and two main landing gears are provided and the hydraulic pump (12) is arranged at the fuselage landing gear and can be connected to the hydraulic supply of the landing gear brakes of the main landing gears via hydraulic lines.

16. Aircraft landing gear in accordance with claim 13, wherein a fuselage landing gear assembly and two main landing gears are provided and the hydraulic pump (12) is arranged at the fuselage landing gear and can be connected to the hydraulic supply of the landing gear brakes of the main landing gears via hydraulic lines.

17. Aircraft landing gear in accordance with claim 2, wherein the hydraulic pump (12) is provided with an adjustment device for the adjustment of the delivery volume, is in particular made as an axial piston pump with an adjustable stroke regulation mechanism.

18. Aircraft landing gear in accordance with claim 3, wherein the hydraulic pump (12) is provided with an adjustment device for the adjustment of the delivery volume, is in particular made as an axial piston pump with an adjustable stroke regulation mechanism.

19. Aircraft landing gear in accordance with claim 4, wherein the hydraulic pump (12) is provided with an adjustment device for the adjustment of the delivery volume, is in particular made as an axial piston pump with an adjustable stroke regulation mechanism.

20. Aircraft landing gear in accordance with claim 13, wherein the hydraulic pump (12) is provided with an adjustment device for the adjustment of the delivery volume, is in particular made as an axial piston pump with an adjustable stroke regulation mechanism.
